(19) United States
(12) Patent Application Publication
(10) Pub. No.: US 2025/0122945 A1
(43) Pub. Date: Apr. 17, 2025

(54) CAPTURING ESCAPING FLUID ON A SAFETY VALVE

(71) Applicant: Dresser, LLC, Houston, TX (US)

(72) Inventor: Rajesh Krithivasan, Jacksonville, FL (US)

(21) Appl. No.: 18/913,140

(22) Filed: Oct. 11, 2024

Related U.S. Application Data
(60) Provisional application No. 63/590,021, filed on Oct. 13, 2023.

(51) Int. Cl. F16K 25/02

(52) U.S. Cl. CPC F16K 25/02

(57) ABSTRACT

A seal is configured to reduce leak rates on a safety valve. These configurations may direct escaping material through a tortuous flow path that can significantly dissipate the amount of flow that exits the device. This tortuous flow path may include features, like undulations or loops, which can affect flow in a way that achieves these exit parameters for the flow.

### CROSS-REFERENCE TO RELATED APPLICATIONS

This application claims the benefit of priority to U.S. Ser. No. 63/590,021, filed on Oct. 13, 2023, and entitled “CAPTURING ESCAPING FLUID ON A SAFETY VALVE.” The content of this application is incorporated by reference herein in its entirety.

### BACKGROUND

Flow controls play a significant role in many industrial settings. Power plants and industrial process facilities, for example, use different types of flow controls to manage flow of material, typically fluids, throughout vast networks of pipes, tanks, generators, and other equipment. Safety relief valves are “fail-safe” devices that protect against rapid increases in pressure on the lines in these networks. Also known as “safety” valves, or “pressure relief” valves, these devices are necessary to avoid “overpressure” conditions that can cause damage to equipment or parts of facilities.

Safety valves may use different mechanisms to generate a closing or “biasing” force to maintain its closure member in contact with its seat. The resulting seal in this “seating area” prevents flow of material, unless a spike in system pressure occurs that overcomes the “set point” to open the valve. Pilot-operated safety relief valves (POSRVs) use system fluid, often under control of a fluid control module, to trigger operation as between its closed position and its open position. In other devices, coil springs and like devices may generate the biasing load. It has been found, though, that material may still leak through the seal at the seating area, even in response to system pressure that is below the set point for the device. Likewise, a material's density or other properties may also cause or exacerbate leaks. Compressible fluids may leak more than incompressible fluids, for example, because compressible fluids have a lower density than incompressible fluids.

### SUMMARY

The subject matter of this disclosure relates to improvements to flow controls. Of particular interest are embodiments that can prevent or capture material that leaks from the seating area of the device. These embodiments may direct leakage into flow paths that are configured to moderate flow and, thus, reduce leak rate from the seating area, or even eliminate leakage altogether. These configurations may include tortuous or circuitous geometry, for example, labyrinth-style designs that create recirculation regions throughout its length. Other configurations may reverse or re-direct leakage flow to prevent escape of material from the seal or seating area. These configurations may employ geometry, like fluidic diodes, that can bias flow in only one direction, or when in use here, can reverse direction of flow to impede escape of fluid out of the device.

### DRAWINGS

This specification refers to the following drawings:

FIG. 1 depicts an exemplary embodiment of a leak capture unit for use in a safety valve;

FIG. 2 depicts an example of structure for the leak capture unit of FIG. 1;

FIG. 3 depicts an example of structure for the leak capture unit of FIG. 1;

FIG. 4 depicts a plot of data that corresponds with computational fluid dynamic analysis of an example of a metal-to-metal seal;

FIG. 5 depicts a plot of data that corresponds with computational fluid dynamic analysis of an example of a metal-to-metal seal;

FIG. 6 depicts a plot of data that corresponds with computational fluid dynamic analysis of an example of the leak capture unit of FIG. 2;

FIG. 7 depicts a plot of data that corresponds with computational fluid dynamic analysis of an example of the leak capture unit of FIG. 3; and

FIG. 8 depicts a perspective view of exemplary structure for the safety valve of FIG. 1.

These drawings and any description herein represent examples that may disclose or explain the invention. The examples include the best mode and enable any person skilled in the art to practice the invention, including making and using any devices or systems and performing any incorporated methods. The drawings are not to scale unless the discussion indicates otherwise. Elements in the examples may appear in one or more of the several views or in combinations of the several views. The drawings may use like reference characters to designate identical or corresponding elements. Methods are exemplary only and may be modified by, for example, reordering, adding, removing, and/or altering individual steps or stages. The specification may identify such stages, as well as any parts, components, elements, or functions, in the singular with the word “a” or “an;” however, this should not exclude plural of any such designation, unless the specification explicitly recites or explains such exclusion. Likewise, any references to “one embodiment” or “one implementation” does not exclude the existence of additional embodiments or implementations that also incorporate the recited features.

### DESCRIPTION

The discussion now turns to describe features of the examples shown in the drawings noted above. These features address leaks or leakage in safety relief valves that can occur in response to changes in biasing force on the device. These changes may coincide with an increase in system pressure, which is known to reduce or decrease the effective biasing force of a spring or diaphragm on the device. This response may allow material to leak out as system pressure approaches the set point of the device. Compressible and low-density fluids, like air, can exacerbate these problems, particularly at temperatures high enough to further reduce the density of these fluids. Thermal deflection that can occur at these high temperatures may also make leaks worse because critical parts may deflect or distort enough to frustrate effective seals. Other embodiments are within the scope of this disclosure.

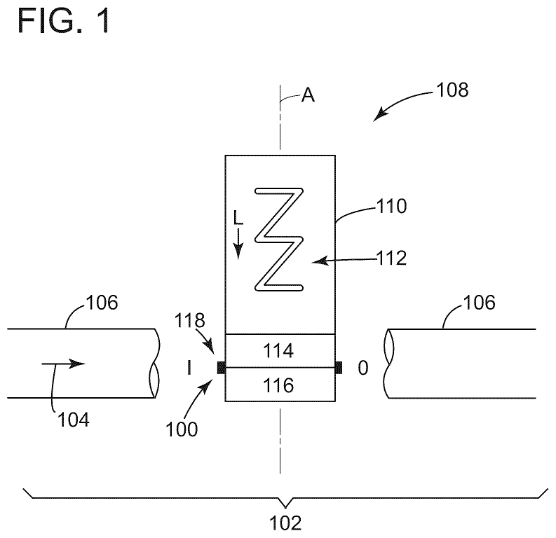

FIG. 1 depicts a schematic diagram of an example of a seal 100. This example is found in a distribution network 102, typically designed to carry material 104 through a network of conduit 106. The network 102 may include a flow control 108 that has a valve body 110 to connect in-line with the conduit 106. The flow control 108 may also have a pre-load unit 112 to generate a load L that maintains a closure member 114 in contact with a seat member 116. As also shown, the seal 100 may include a leak capture unit 118, shown here in proximity to the contact interface between the closure member 114 and the seat 116.

Broadly, the seal 100 may be configured to reduce leaks in safety valves. These configurations may direct escaping fluid through pathways that can capture some or all of the escaping fluid, or at least dissipate its energy, to reduce the amount that leaks back into the outlet and out of the device. These features are useful to maintain leak rates within ranges acceptable to operators of various facilities, including thermal hydraulic power plants, nuclear facilities, and the like.

The distribution system 102 may be configured to deliver or move resources. These configurations may embody vast infrastructure. Material 104 may comprise gases, liquids, solid/liquid mixes, or liquid-gas mixes, as well. The conduit 106 may include pipes or pipelines, often that connect to pumps, boilers, and the like. The pipes may also connect to tanks or reservoirs. In many facilities, this equipment forms complex networks.

The flow control 108 may be configured to release pressure in these complex networks. These configurations may include safety relief valves and like devices. The valve body 110 is often made of cast or machined metals. This structure may form a flange at openings, identified here as “I” and “O.” Adjacent pipes 106 may connect to these flanges. The pre-load unit 112 may include devices that can generate the load L. These devices may store energy, for example, as a result of deflection or like change in length or size. Coiled or compression springs may prevail for this purpose because they may compress or extend in response to changes in system pressure P. Other devices may incorporate pilot valves into the design that use an air supply to maintain the load L as desired. The members 114, 116 may form a metal-to-metal seal at the contact interface; however, this disclosure contemplates elastomer-to-metal seals or elastomer-to-elastomer seals, as well. This metal-to-metal seal is effective in harsh conditions, for example, in networks that move caustic or hazardous materials or materials at high temperature or high pressure.

The leak capture unit 118 may be configured to capture any material that transits or leaks through the metal-to-metal seal or other seal found at the contact interface. These configurations may include devices that reside in position at or near the members 114, 116. These devices may form an annular ring, for example, that circumscribes all or some of the members 114, 116. This ring may comprise one or more flow paths, typically formed integrally into structure of the ring. It is also possible for the flow paths to form integrally with one or more of the members 114, 116. Additive manufacturing (including 3D printing) and like manufacturing techniques may prove useful to construct the annular ring (and the members 114, 116) with this structure inside. The flow paths may adopt designs, for example, that retain or impede flow of material through the ring. This feature may reduce the rate of flow (or “leak rate”) of material that effectively leaks from the outlet O of the flow control 108 because it decreases, or eliminates, the leak rate of material from one end to the other end of the flow path.

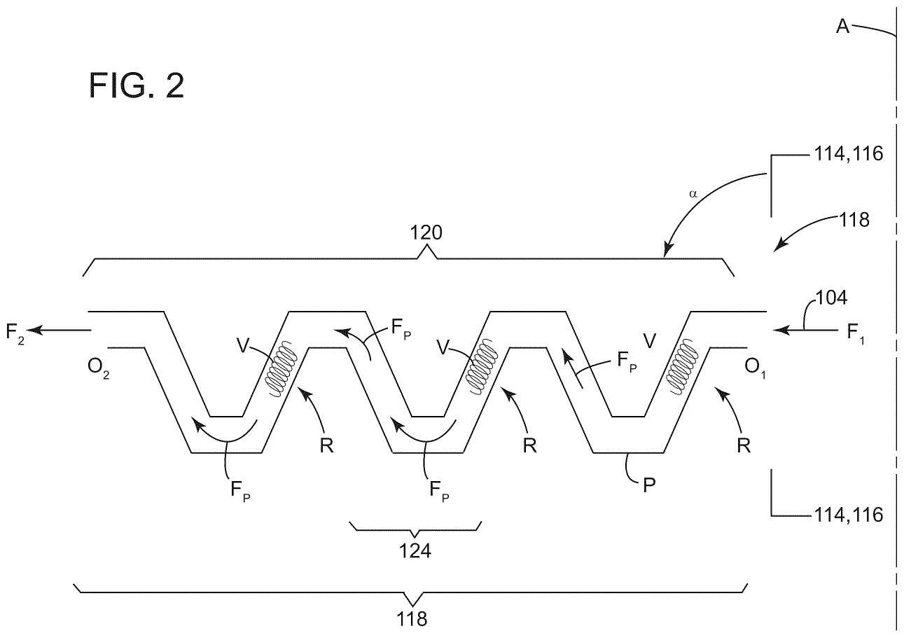

FIG. 2 depicts a schematic diagram of exemplary structure for the leak capture unit 118. This structure may include a flow path 120 with ends that terminate at openings O₁, O₂. The first or proximal opening O₁ may reside proximate the members 114, 116. The proximal opening O₁ can receive flow F₁ of material 104 that escapes from the contact interface between members 114, 116. In one implementation, flow F₁ can enter a pathway P that extends in a direction radially away from the members 114, 116. The direction may reside at an angle α relative to the axis A. Values for the angle α may arrange the pathway P perpendicular to the axis A; however, other values for the angle α may prevail as well. In one implementation, the pathway P may adopt a geometry that may change characteristics of flow Fₚ that transits between the openings O₁, O₂. This geometry may form a “labyrinth” or like tortuous shape that induces vortexes V or vortex-like motion at or near recirculation regions R. A series of adjacent or contiguous waves or undulations 124 in the shape may prevail for this purpose. In use, the recirculation regions R may effectively stall or entrap all or part of flow F₁ inside of the leak capture unit 118. This feature may, in turn, result in a flow (or “leakage”) F₂ of material 104 that exits the second or distal opening O₂ of the flow path 120 that is less than flow F₁.

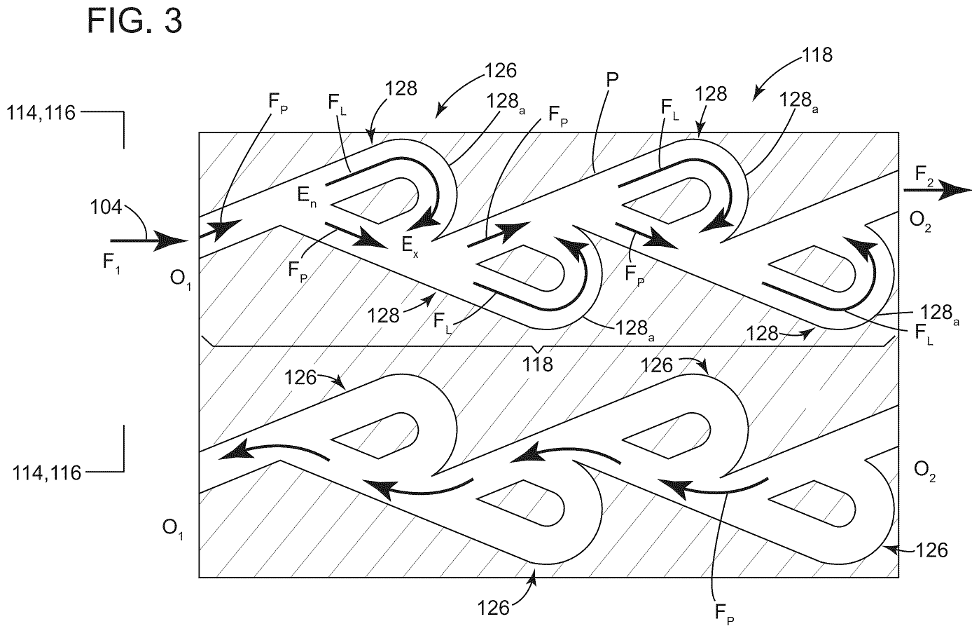

FIG. 3 depict schematic diagrams of exemplary structure for the leak capture unit 118. This structure may adopt geometry that influences characteristics of flow Fₚ through the leak capture unit 118. This geometry may integrate certain “fluid logic” elements into the design. Use of these elements may allow flow between the openings O₁, O₂ to occur only in a single, preferential direction, preferably back towards the proximal opening O₁. A series of fluid diodes 126 may populate pathway P along its length for this purpose. The fluid diodes 126 may include a loop 128 that couples with the pathway P at an entrance Eₙ and an exit Eₓ. The loop 128 may have a curved portion 128a that terminates at the exit Eₓ. In use, a portion F_{L} of flow Fₚ may divert from the pathway P through the entrance Eₙ and into the loop 128. The curved portion 128a may direct portion F_{L} back into the pathway P (at the exit Eₓ) in a direction that is opposite to, or at an angle to, flow Fₚ. This opposite direction creates a reverse flow F_{R} that mixes with flow Fₚ in the pathway and, in turn, may block or impede flow Fₚ in the pathway P as it transits toward the distal opening O₂. This feature may, in turn, result in leakage F₂ of material 104 that exits the distal opening O₂ of the flow path 120 that is less than flow F₁. In one implementation, the use of fluid diodes 126 may effectively eliminate leakage F₂ at the distal opening O₂ altogether. However, as shown in the lower diagram of the pathway P, use of fluid diodes 126 do not interfere with flow Fₚ from the distal opening O₂ towards the proximal opening O₁. This feature may find use to direct flow back towards the members 114, 116, which can also reduce leak rate of material from the outlet O of the flow control 108 (FIG. 1).

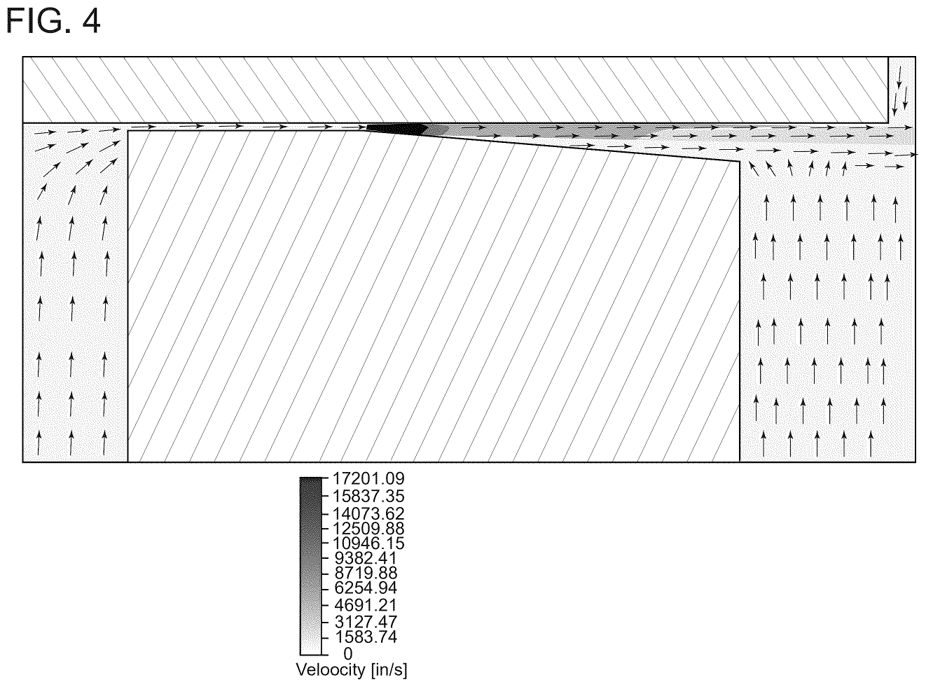

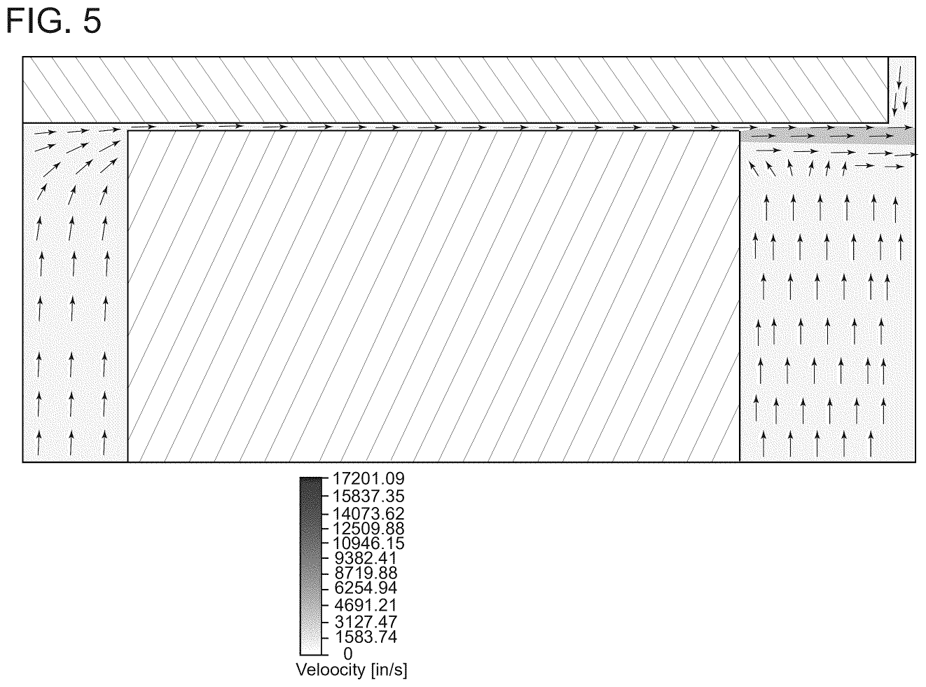

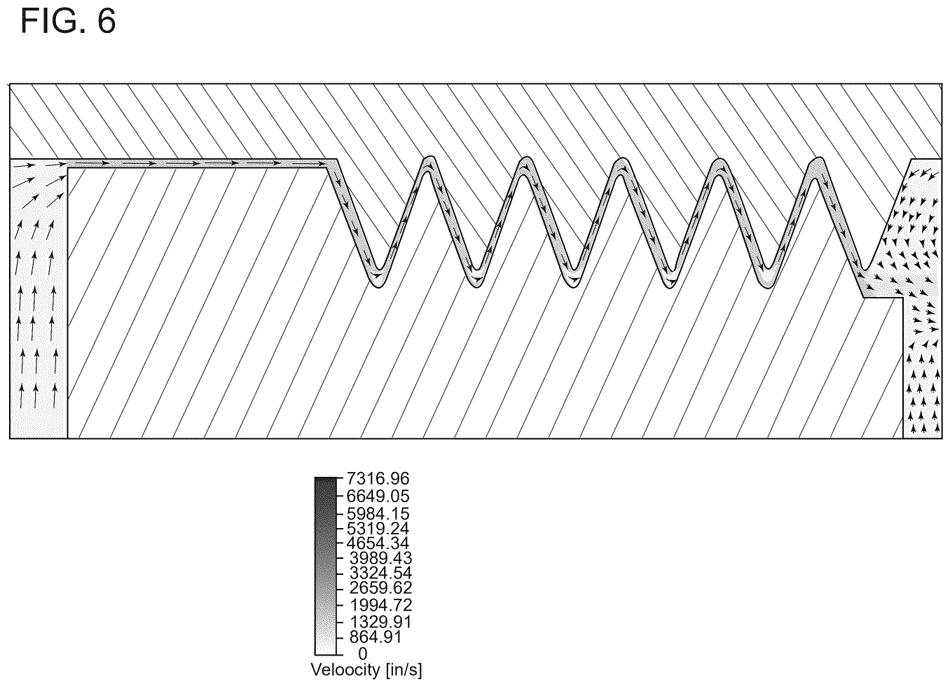

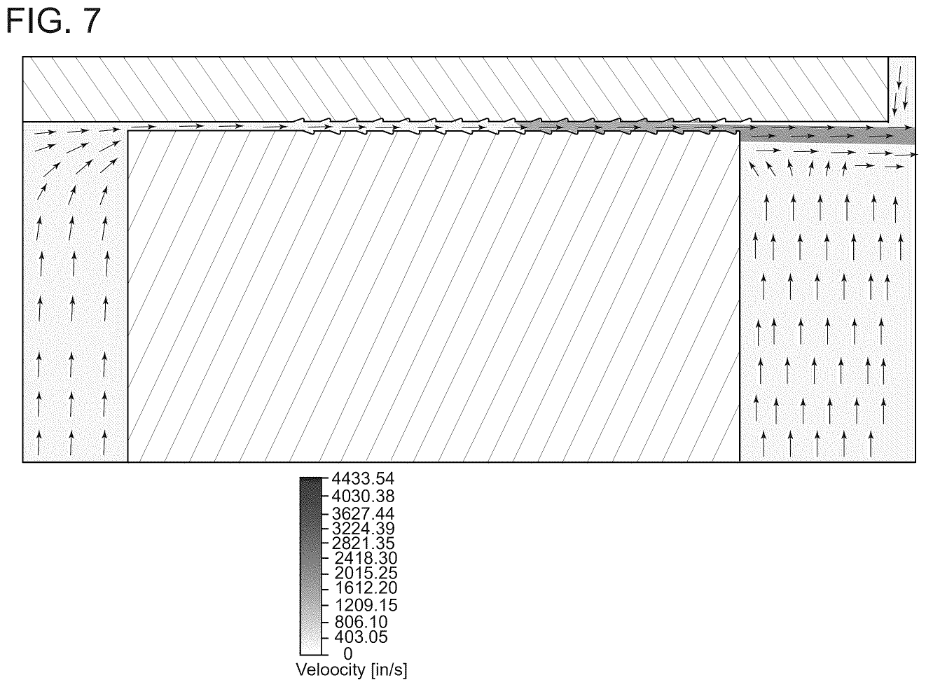

FIGS. 4, 5, 6, and 7 depict plots of data that correspond with computational fluid dynamic (CFD) analysis of that models behavior of exemplary models fir the leak capture unit 118 and the seal 100 discussed herein. The plots of FIGS. 4 and 5 corresponds with data that results from CFD analysis of “conventional” seals. For example, the plot of FIG. 5 shows modeled flow for a metal-to-metal seal with a “standard” leak path. In FIG. 5, the plot shows modeled flow of a metal-to-metal seal with an “elongated” leak path. This elongated leak path may have a length that is the same as (or like) the length of a “labyrinth” style pathway P (of FIG. 2) or that corresponds to similar tortuous geometry. In this connection, the plots of FIGS. 6 and 7 correspond with data that results from CFD analysis of a “labyrinth” style pathway P (FIG. 2) and a “fluid logic” style pathway P (FIG. 3), respectively.

TABLE A
Table A below summarizes these results.

| | | % Reduction in | |
|---|---|---|---|
| | | Leak Rate | |
| | | vs. Standard | vs. Elongated |
| | Leak Rate | metal-to- | metal-to- |
| Design | (lb/sec) | metal seal | metal seal |
| Standard | 0.000146822 | N/A | N/A |
| Elongated Standard | 0.000075037 | N/A | N/A |
| “Fluid logic” | 0.00004625 | 68.5% | 38% |
| “Labyrinth” | 0.000824226 | 43.9% | −9.8% |

Comparatively, the data shows that the “labyrinth” style pathway P and the “fluid logic” style pathway P both reduce leak rate as compared to a standard seal design. The “fluid logic” style pathway P is also more effective as compared to the conventional seal with the elongated leak path.

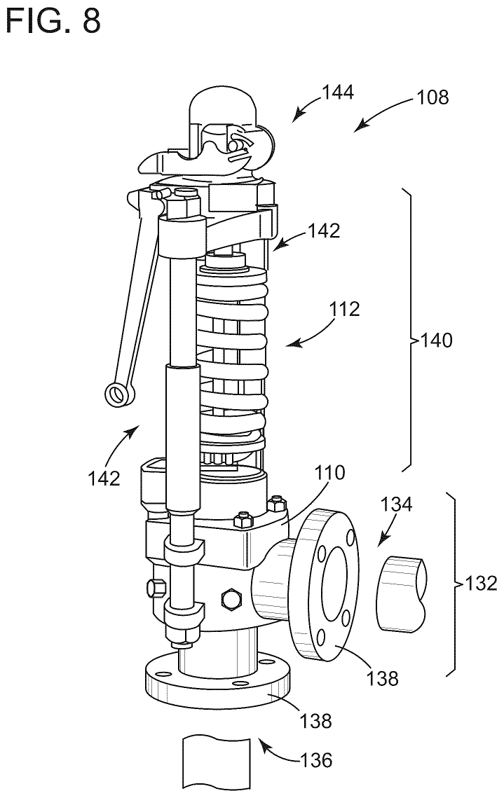

FIG. 8 depicts a perspective view of structure for the flow control 108. The body 110 may form a robust, fluid coupling 132 with a pair of openings (e.g., a first opening 134 and a second opening 136). The fluid coupling 132 may be configured to handle pressure of various fluids, including, for example, steam that is common to nuclear facilities and like power plants. These configurations may have structure, typically of cast, forged, or machined metal, to form a flow path for fluid to flow between pipes P₁, P₂. Flanges 138 (or other joint connections) at the openings 134, 136 may outfit the fluid coupling 132 to couple to pipes. Fasteners like bolts may be used to ensure secure connection. The structure may also have a bonnet 140 with structural members 142 that attach to the fluid coupling 132. The structural members 142 may be of various construction. A mechanical actuator 144 may reside on top of the bonnet 140. The mechanical actuator 144 may couple with the preload unit 112 to pre-load the compression spring.

Considering the foregoing, the improvements herein may reduce leak rates on safety relief valves. These improvements can maintain pressure relief valves (PRVs) in their “leak tight” state until system pressure meets or exceeds set point (or a pre-determined actuation pressure) for the device. This feature addresses problems with some valves that begin to open in response to system pressure that is below this set point. On the other hand, seals consistent with this disclosure can prevent unnecessary escape of materials and are compatible with extreme operating conditions (for example, high temperatures and high pressures,) and caustic materials that foreclose use of more conventional elastomer or “soft” metal material.

The examples below include certain elements or clauses to describe embodiments contemplated within the scope of this specification. These elements may be combined with other elements and clauses to also describe embodiments. This specification may include and contemplate other examples that occur to those skilled in the art. These other examples fall within the scope of the claims, for example, if they have structural elements that do not differ from the literal language of the claims, or if they include equivalent structural elements with insubstantial differences from the literal language of the claims.

What is claimed is:

1. A safety valve, comprising:
a pre-load unit that is configured to generate a load;
a closure member under influence of the load;
a seat in proximity to the closure member, wherein the closure member and the seat are configured to contact one another to form a seal in a closed position; and
a leak capture unit disposed outside of the seal and comprising a flow path to receive flow of material that exits the seal.

2. The safety valve of claim 1, wherein the leak capture device circumscribes the seal.

3. The safety valve of claim 1, wherein the leak capture device is part of the seal.

4. The safety valve of claim 1, wherein the flow path has a tortuous geometry.

5. The safety valve of claim 1, wherein the flow path comprises a series of undulations.

6. The safety valve of claim 1, wherein the flow path is configured to create vortex-like flow.

7. The safety valve of claim 1, wherein the flow path is configured with regions to contain material in a vortex-like flow.

8. The safety valve of claim 1, wherein the flow path comprises a fluid logic structure.

9. The safety valve of claim 1, wherein the flow path comprises a fluid diode.

10. The safety valve of claim 1, wherein the flow path comprises a series of fluid diodes.

11. A valve, comprising:
a seat;
a closure member moveable relative to the seat, the closure member having a position in contact with the seat that forms a contact interface; and
a leak capture unit that circumscribes the contact interface, the leak capture unit comprising a flow path terminating at a first opening and a second opening on either end, respectively,
wherein the flow path is configured to impede flow so that flow that enters at the first opening is less than flow that exits at the second opening.

12. The valve of claim 11, wherein the flow path causes the flow to form a vortex.

13. The valve of claim 11, wherein the flow path causes a portion of flow to change direction and to mix with flow in the flow path.

14. The valve of claim 11, wherein the flow path follows a non-linear direction radially way from the contact interface.

15. The valve of claim 11, wherein the flow path is perpendicular to an axis of the closure member.

16. The valve of claim 11, wherein the leak capture unit comprises fluid diodes disposed along the flow path.

17. The valve of claim 11, wherein the leak capture unit comprises a loop with an entrance and an exit, both coupled with the pathway, so that a portion of flow from the pathway enters through the entrance and exits through the exit in a direction that is opposite of flow in the pathway.

18. A method, comprising:
receiving flow into a pathway that is adjacent to a contact interface found between a closure member and a seat in a valve; and
directing the flow in the pathway in a manner that impedes the flow so that the flow that enters the pathway is less than the flow the exits the pathway.

19. The method of claim 18, further comprising:
providing a seal around the contact interface, the seal comprising the pathway.

20. The method of claim 18, further comprising:
providing a seal around the contact interface, the seal comprising the pathway, the pathway extending radially way from the contact interface.
